(19) United States
(12) Patent Application Publication
(10) Pub. No.: US 2026/0111647 A1
(43) Pub. Date: Apr. 23, 2026

(54) Integration System For Computing Device Networks

(71) Applicant: Ordr, Inc., Santa Clara, CA (US)

(72) Inventors: Madhava Krishna Kidambi, San Jose, CA (US); Deepak Cherian, Newark, CA (US); Senthil Arunachalam, Fremont, CA (US)

(73) Assignee: Ordr, Inc., Santa Clara, CA (US)

(21) Appl. No.: 18/919,631

(22) Filed: Oct. 18, 2024

(51) Int. Cl. G06F 40/106; G06F 3/0482; G06F 8/38; G06F 9/451; G06F 9/54; G06F 40/117; G06F 40/154; G06F 40/174

(52) U.S. Cl. CPC G06F 40/106; G06F 3/0482; G06F 8/38; G06F 9/451; G06F 9/54; G06F 40/117; G06F 40/154; G06F 40/174

(57) ABSTRACT

Techniques for integrating a computer device network with a third-party resource are disclosed. In one embodiment, a system analyzes a first meta-specification to identify (a) a plurality of datasets needed for accessing a third-party database and (b) a data type associated with each of the plurality of datasets; selecting an interface layout for generating a GUI that includes a plurality of interface elements for collecting values for the plurality of datasets, wherein a particular interface element, of the plurality of interface elements, for collecting a particular value for a particular dataset is selected based on the data type associated with the particular dataset; and generating the GUI based on the interface layout. The system, using customer provided information via the interface generated from the first meta-specification, generates computer code to access the third-party cloud resource based on a second meta-specification.

### TECHNICAL FIELD

The present disclosure relates to computing device networks. In particular, the present disclosure relates to computing device network management and maintenance.

### BACKGROUND

The technology behind today's computing device networks allows an entity to expand their computing device network from networks of enterprise servers, desktops, and laptops to much larger networks that also include smartphones, tablets, Artificial Reality/Virtual Reality (AR/VR) systems, operational technologies (OT), Internet of Things (IoT) devices, and/or the like. The sheer number and variety of devices exposes the entity to several issues such as cybersecurity problems; without real-time visibility and monitoring of an asset, the entity's computing device network is vulnerable to operational disruptions. To do so, the entity integrates various data sources to collect information of interest to their needs. Some of that information can be stored behind an access mechanism, such as in a private data source and/or in a data source outside of the entity's computing device network (i.e., a remote data source). Prior to obtaining access to such information, the entity first negotiates an access mechanism to the data source. If any information is time-sensitive, the entity negotiates the access mechanism quickly; otherwise, its informational value may be depleted.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for automating an integration between a computing device network in accordance with one or more embodiments;

FIG. 3A illustrates an example embodiment for an interface for collecting values for a plurality of datasets needed for accessing a third-party database;

FIGS. 3B and 3C illustrate an example embodiment of a meta-specification configured to identify the plurality of datasets from which the interface is generated in accordance with one or more embodiments;

FIG. 4A illustrates an example embodiment for an interface for presenting results from execution integration computer code on a third-party database;

FIG. 4B illustrates an example embodiment of a meta-specification configured to define the integration computer code in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. INTRODUCTION
2. GENERAL OVERVIEW
3. INTEGRATION SYSTEM FOR A COMPUTING DEVICE NETWORK
4. AUTOMATING AN INTEGRATION FOR A COMPUTING DEVICE NETWORK
5. EXAMPLE EMBODIMENTS
   a. FIRST META-SPECIFICATION
   b. SECOND META-SPECIFICATION
6. COMPUTER NETWORKS AND CLOUD NETWORKS
7. MICROSERVICE APPLICATIONS
8. HARDWARE OVERVIEW
9. MISCELLANEOUS; EXTENSIONS

### 1. Introduction

Various embodiments described herein advantageously use meta-specification data for automating an integration process between an entity's computing device network and a third-party resource such as a third-party database. The various embodiments use the meta-specification data to facilitate the integration process first by generating a graphical user interface (GUI) for enabling communications to an Application Programming Interface (API) and then by generating computer code for integrating the entity's resource(s) with the third-party resource.

One embodiment of the meta-specification data, a GUI meta-specification, defines a plurality of datasets for accessing the third-party resource. The GUI meta-specification also defines a plurality of target datasets to be retrieved upon successfully accessing the third-party resource. An example dataset value can be an input parameter to a function call while an example target dataset value can be an output result of that function call. The GUI meta-specification data ensures that the dataset values and/or the target dataset values are properly typed, named, and formatted. Another embodiment of the meta-specification data, an API meta-specification, defines a set of functions and introduces a code template for performing different integration tasks. The set of the functions can be invoked for accessing the third-party resource and/or retrieving the target dataset values. The API meta-specification data ensures that any value used in a function call is properly typed, named, and formatted.

### 2. General Overview

The following describes various embodiments and a number of ways that these embodiments can benefit an entity's computing device network. Some embodiments configure a system to leverage meta-specification data to confer advantages to the entity's computing device network. The system can provide a view of connected devices in the entity's computing device network—from managed devices, such as servers and PCs as well as unmanaged assets, such as IoT, IoMT, and OT devices—and collect accurate details. The system relies on insights and other third-party information of interest to produce and enhance this view. Although this information can be requested via a GUI and sent from a third-party resource via an API, several manual processes and tedious forms need to be completed before any data can be communicated.

Among the challenges to a successful integration between the entity's computing device network and the third-party resource, the customer's information technology (IT) personnel as well as engineers and/or developers engage in the tedious back-and-forth procedure of exchanging data in preparation of the integration process. Such an exchange involves collecting device features and then manually developing suitable code for extracting various information of interest from the third-party resource. Some device features include device configurations, endpoint (i.e., asset) identifiers, network addresses, device make/model, software versions, physical locations, policies, API information, device classifications, and other potential integration parameters. Some devices, such as IoT devices, were not designed with an interface, and many devices do not use the same schema for their device data. Even though certain use cases can exacerbate the tedious back-and-forth process, such as in the healthcare context where Internet of Medical Things (IoMT) devices are used, the system described herein overcomes these and other challenges with an integration solution in which the meta-specification data enables the system to obtain insights and generate suitable code for extracting device data almost immediately, resulting in a more rapid and successful integration.

Various embodiments described herein use the above-described meta-specification data for negotiating access to the third-party resource; this requires knowledge of both the specific datasets that are necessary to obtain authorization and the datasets that will be acquired due to having information of interest to the entity's needs, including their cybersecurity needs.

To further reduce or eliminate delays caused by the above-mentioned manual procedure, some embodiments use the meta-specification data to automatically generate a GUI for collecting the necessary datasets for quickly or automatically developing the integration computer code. The system uses the meta-specification data for setting type, variable name, and format information of each dataset being requested from the customer, ensuring that the collected information is correctly typed, formatted, and named and that the code is properly developed. One or more embodiments generate the GUI with interface elements that are selected, at run-time, based on the type of data to be received via the GUIs.

To avail the functionality exposed by an API for the third-party resource, some embodiments generate the necessary computer code that operates the API and completes a number of integration tasks. Using the data provided via the GUI, the system can make proper API function calls. Instead of a time-consuming manual procedure, the various embodiments described herein automate the acquisition and subsequent use of the above-mentioned datasets in a successful integration of the third-party resource with a resource controlled by the entity's computing device network.

Some embodiments described herein advantageously use templates for completing an integration process. A template generally refers to a data file (e.g., a HTML document) comprising markup data in which a first metadata portion sets forth a number of integration parameters (i.e., the GUI meta-specification) and a second metadata portion sets forth a number of integration tasks (i.e., the API meta-specification). A content portion of the markup data can be rendered into an Internet page such as a dynamic web form. The Internet page may present input form fields for receiving integration parameters values and/or output form fields for presenting integration task results. Depending on the third-party resource, the first metadata portion may further describe each parameter, for example, by format, type, name, and/or the like. In this manner, the integration parameter types/names are customizable but do not require additional code and/or markup data when being incorporated into a custom interface. One embodiment can select, at run-time, compatible form fields to insert into the content portion for receiving parameters values via the GUI. The first metadata portion may further include code snippets operative to execute various operations on the received parameter values (e.g., normalization) such as when the third-party resource or the computing device network requires a specific format.

The system can use the second metadata portion and the received parameters values to generate executable computer code configured to extract information of interest to the entity. One embodiment can select, at run-time, compatible parameter values to insert into a code template for generating the executable computer code. Similar to the GUI meta-specification of the first metadata portion, the API meta-specification of the second metadata portion specifies the correct name, type, and format for these compatible parameter values. To illustrate by way of example, the received parameter values can be input into a first API function call to obtain access to the third-party resource. In addition to the received parameter values for the first API function, another parameter value can returned by the first API function and then used as an input parameter value when calling a second API function.

Some embodiments advantageously use the above-described meta-specification data, for instance, to present, on a customer/end user's device, a dynamic web form document populated with appropriate form fields for receiving input parameter values for integration tasks. For instance, a developer can compile a JSON file to define the target datasets and the operations needed for accessing and retrieving the target datasets. This JSON file can then be used to automatically generate a custom interface by selecting, at runtime, particular interface elements based on some rules. This JSON file can then be used to automatically generate custom code by executing API function calls based on some rules. For instance, custom code can be generated for collecting target datasets and, possibly, another integration task such as enforcing a policy. Other integration tasks handled by the executable integration code include determining a network topology, detecting a vulnerability, generating a ticket for an IT issue, performing investigations, updating the customer database to unify device details, enriching device context, identifying policy violations or security risks, and/or the like. Some integration tasks provide the customer with insights gleaned from the third-party information of interest such as security analysis information. The system can use the custom interface to present updated integration information, security warnings, notifications, tickets, etc.

One or more embodiments described in this Specification and/or recited in the claims may not be included in this General Overview section.

### 3. Integration System for a Computing Device Network

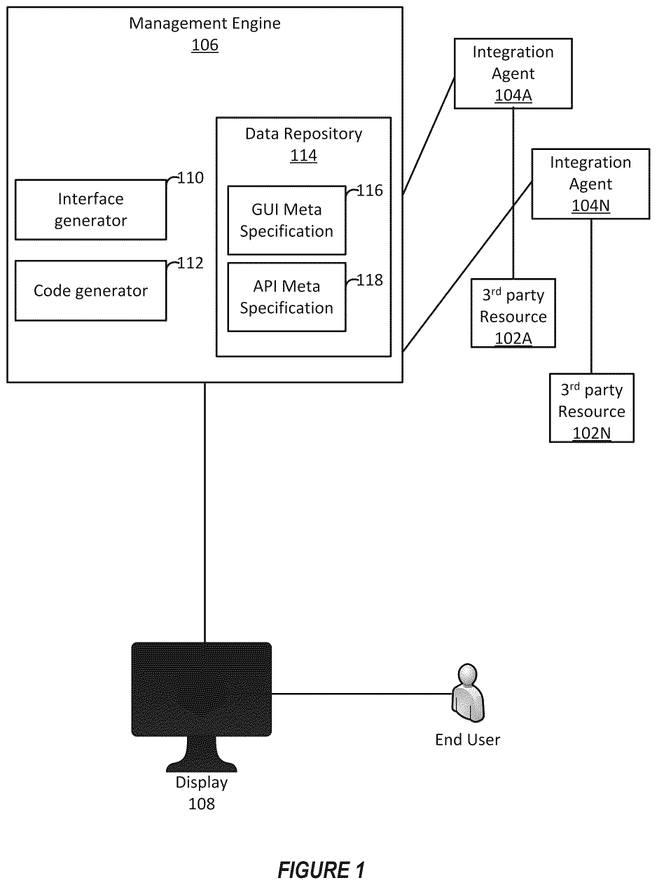

FIG. 1 illustrates a system 100 in accordance with one or more embodiments. As illustrated in FIG. 1, the system 100 includes a plurality of third-party resources 102A-102N with which a plurality of integration agents 104A-104N perform an integration process, specifically, to integrate a computing device network with available information of interest. As described herein, an entity operating the computing device network can be a customer of the system 100.

In general, a third-party resource as described herein operates as a data source and an access mechanism for specific third-party information of interest. The third-party resource can obtain the third-party information of interest from devices and other sources. Some have agents running on these devices that pull/push information from the devices to a remote data store on their own respective clouds. To later retrieve device information from the third-party resource, a custom interface is built through which the customer can submit network and/or device information and in response, receive information of interest. However, the customized interface and/or the computer code used to obtain access require a manual back-and-forth building procedure. In addition to an incomplete specification, there are specific dataset attributes and values needed for the custom interface and/or the computer code and these generally are unknown to the user interface (UI) and/or software developers. Such information is typically exchanged prior to building the custom interface and/or the computer code. The specific datasets describe input parameters for function calls, embedded credentials for the access mechanism, endpoint attributes of the information of interest, frequencies for the integration process, and/or the like.

Operating on behalf of its customer, various embodiments of the system 100 continuously acquire recent third-party information of interest and update its customer's own data stores as part of the integration process. Access to the third-party information of interest is controlled by any one of the third-party resources 102, which may be a database application and/or a cloud service. Any of the third resources (e.g., 3rd party resources 102A . . . 102N) may be implemented within a same system as the corresponding integration agent, a same system as the management engine 106 and/or remotely (e.g., in a cloud environment or other system). The third-party information of interest can be any information that the customer might find relevant. The third-party resources 102 can use a data model to define certain datasets of information of interest to be retrieved during the integration; however, the third-party resources 102 do not use the same data model and can differ greatly when it comes to how their datasets are data typed, formatted, named, and so forth. The third-party information of interest may be stored in a remote storage location and therefore, require transmission over a communication network to reach its ultimate destination per the integration process.

The system 100, which may be known as an integration system, includes a management engine 106. The plurality of integration agents 104A-104N (hereinafter referred to as “the plurality of integration agents 104” or simply “the integration agents 104”) operates in between the plurality of third-party resources 102A-102N (hereinafter referred to as “the plurality of third-party resources 102” or simply “the third-party resources 102”) and the management engine 106. In general, the management engine 106 includes a number of hardware/software components for automating the integration process between the computing device network and one or more third-party resources 102. In one embodiment, the management engine 106 automates, or at least facilitates, a third-party integration process by determining the datasets that are needed to access various information of interest being stored by the plurality of third-party resources 102, to build a suitable GUI through which such datasets can be requested and received from the customer, and then to automatically generate appropriate computer code for retrieving the various information of interest. In one embodiment, the management engine 106 configures a device known as a display 108 to present the above GUI to the customer or the customer's employee. In one embodiment, the management engine 106 configures selective ones of the plurality of integration agents 104 to execute and possibly store the above computer code for later use.

An end user, as directed by the customer operating the computing device network, can use the management engine 106 of the integration system for a number of integration-related operations. In one embodiment, the management engine 106 generates for display on a display device 108 an interface through which the end user can configure periodic integrations between local or proprietary data stores and one or more third-party resources 102. In one embodiment, the end user can use the display 108 to enter input parameter values for the management engine 106 to use in generating integration computer code for the plurality of integration agents 104 to run when performing the integration process. The interface on the display 108 can also present results from the integration process. The integration computer code (or simply “computer code) may be configured to invoke a RESTful API that uses HTTP requests to access and retrieve the information of interest from the one or more third-party resources 102. Alternatively, or additionally, the computer code may be configured to execute SQL queries to retrieve information of interest from the one or more third-party resources 102.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.” In one embodiment, the management engine 106 of the integration system automates an integration process between a customer database for the computing device network and one or more third-party databases for the external service or application. The external service or application can be tasked with different operations that benefit the computing device network. While doing so, the plurality of third-party resources 102 records datasets of third-party information of interest generated by the external service or application. In one embodiment, the computing device network is composed of various types of devices that the external service or application monitors, secures, enhances, and otherwise manages on behalf of the customer. The devices of the computing device network include customer assets that may be herein referred to as “assets” for the sake of brevity, but it is not a requirement that all devices are assets of a customer according to several embodiments.

As illustrated in FIG. 1, the management engine 106 includes interface generator 110, code generator 112, and a data repository 114. The data repository 114, as further illustrated, stores various computer data, including a GUI meta-specification 116 and an API meta-specification 118. Each meta-specification generally refers to computerized data, as in metadata, for describing a specification of some kind, which can be any one amongst a variety of specification examples. Meta-specification data typically includes hierarchically structured data in which the information defines an object model, a data schema, a service architecture, and/or the like. The meta-specification data itself can be considered a specification involving a data schema and/or logic for integration tasks. An example meta-specification can be used to both validate a data schema and/or any logic using the data schema and then build a software object to implement the data schema/logic. The software object can then be used in the integration process, for example, by the management engine 106 or a specific component therein, the integration agents 104, or another a software component for accessing the third-party resource and retrieving information of interest. In one embodiment, the API meta-specification includes scripted computer code operative to execute at least one pre-defined function call.

The GUI meta-specification 116 may set forth key-value pairs mapping attributes to an attribute values indicative of an attribute type, an attribute datatype and/or format, or an attribute name. A set of attributes defined as such can be used to describe any object including an asset in the customer's computing device network or an external service or application running on one of the third-party resources 102. For instance, the GUI meta-specification 116 can specify a device by pairing a corresponding device name with a device name attribute and a “text” datatype. The GUI meta-specification 116 can further specify for the same device a corresponding device location attribute with a specific IP address format for the IP address as the device location attribute value and. Some other example attributes describe an identifier (ID) for the device or a device component, a device type, and/or the like.

In this manner, the GUI meta-specification 116 can spell out compatible names and datatypes/formats for any specification that use any of the same attributes such as for computer code variables, API function parameters, GUI interface elements, devices running a service or an application, and so forth. For instance, the GUI meta-specification 116 can define the external service with attributes that specify user credentials, a server URL, or any other dataset for obtaining authorized access to one or more of the third-party resources 102 retrieving target datasets from the one or more of the third-party resources 102. The above definition can be incorporated into a data model behind a custom interface, a GUI, between the entity operating the computing device network and the external service, and the interface generator 110 can then generate a plurality of interface elements to present the GUI to an end user for the entity.

The GUI meta-specification 116 can further define the target datasets with various attributes such as attributes that specify how to present target dataset values on a GUI, attributes that identify pre-defined queries for selecting the target dataset values, and other attributes. In one or more embodiments, the GUI meta-specification 116 may be configured into a template from which the interface generator 110 can generate an interface with interface elements for receiving the necessary values to access the one or more of the third-party resources 102.

The API meta-specification 118 may set forth logic for executing integration tasks for the integration process between the computing device network operated by the entity and the third-party resource(s) 102. The logic generally defines an integration task using function calls including function calls directed to an API for a specific third-party resource 102. Based on the logic, the code generator 112 can generate integration computer code for performing the integration tasks including accessing the specific third-party resource 102 and retrieving information of interest.

One embodiment of the integration computer code includes computer code invoking a set of functions that require, as input, parameter values received from one or more sources. The set of functions may include a first function configured to obtain authorization for accessing at least one of the third-party resources 102, a second function configured to execute pre-defined queries for retrieving a plurality of target datasets, and possibly additional functions. While some parameter values are received as user input via a custom interface, other parameter values are received as returned data from a previous function call.

In one or more embodiments, the API meta-specification 118 may be configured into a computer code template (simply “template”) from which the code generator 112 generates the integration computer code invoking the above set of functions. Compared to the generated integration computer code, the computer code of the template includes the same function calls but with incomplete instructions. For instance, some function calls may be missing parameter values including parameters that are necessary for accessing the specific third-party resource 102 and/or retrieving the information of interest. Having received values of the necessary parameters via the above-mentioned GUI generated by the interface generator 110, the code generator 112 can use the template in the API meta-specification 118 to generate appropriate integration computer code for the function calls into which the received values are input. It should be understood that there are a number of ways to implement the template for the integration system.

In an embodiment, a single template combines the GUI meta-specification 116 and the API meta-specification 118 such that the code generator 112 generates the integration computer code using a same template as (or, alternatively, a different template from) the template used by the interface generator 110 for generating the GUI. The single template may store in its metadata both the GUI meta-specification 116 and/or the API meta-specification 118. This template can therefore be used to generate the GUI and the integration computer code for performing the integration process while enabling the end user to monitor its progress and view results via the GUI.

In general, the integration computer code is operative to access and retrieve third-party information of interest that is unavailable to the entity operating the computing device network and typically includes insights determined or discovered by the third-party but not known to the customer. Although, typically, the third-party information of interest to the customer pertains to specific devices in the computing device network, the third-party resource 102 can retain datasets that do not pertain to specific devices but nonetheless qualify as information of interest.

To illustrate by way of example, the third-party resources 102 may include a third-party database storing security analysis information for the customer's computing device network. CrowdStrike®, for instance, offers at least five primary APIs with several subfunctions that can support a wide range of operations on data stored at a Crowdstrike® cloud. Based on the changing needs of their customers, the management engine 106 can generate a customized dashboard portal and then execute a background process for either streaming or querying data from the third-party database in the CrowdStrike® cloud for proactive threat intelligence, independent investigation, or relationship visualization of the assets in the customer's computing device network.

In one or more embodiments, the data repository 114 is any type of storage unit and/or device (e.g., a file system, database, collection of tables, or any other storage mechanism) for storing data. Furthermore, the data repository 114 may include multiple different storage units and/or devices. The multiple different storage units and/or devices may or may not be of the same type or located at the same physical site. Furthermore, the data repository 114 may be implemented or executed on the same computing system as the interface generator 110 and/or the code generator 112. Additionally, or alternatively, the data repository 114 may be implemented or executed on a computing system separate from the interface generator 110 and/or the code generator 112. The data repository 114 may be communicatively coupled to the interface generator 110 and/or the code generator 112 via a direct connection or via a network.

Information describing the GUI meta-specification 116 and the API meta-specification 118 may be implemented across any of components within the system 100.

However, this information is illustrated within the data repository 114 for purposes of clarity and explanation.

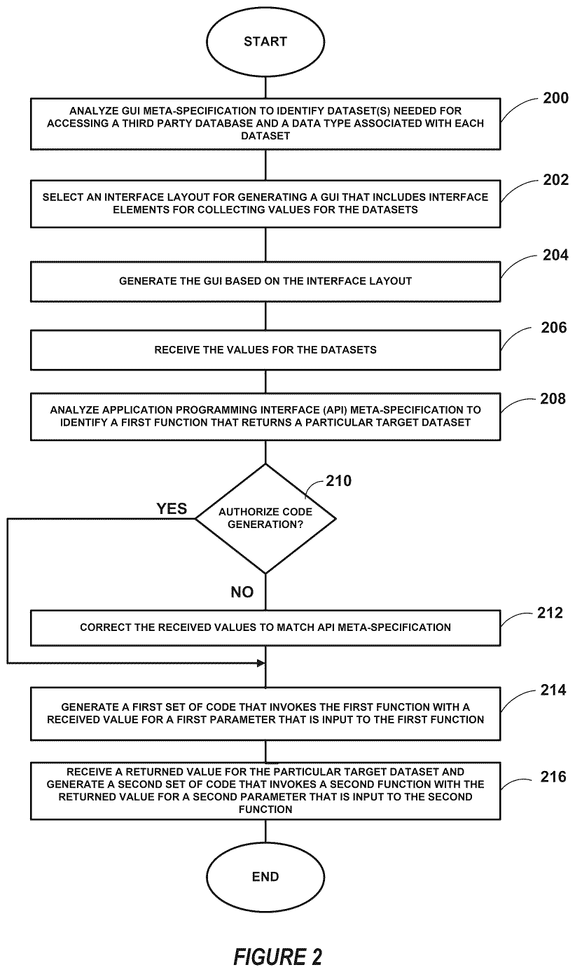

As described herein, the management engine 106 refers to computer hardware and/or software configured to perform operations described herein for automating an integration process between the customer's computer device network and the one or more third-party resources 102. Examples of operations for automating an integration process between the customer's computer device network and the one or more third-party resources 102 are described below with reference to FIG. 2.

In an embodiment, the management engine 106 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the GUI described above refers to hardware and/or software configured to facilitate communications between the end user and the management engine 106. The GUI renders user interface (UI) elements and receives input via user interface elements. Alternatives to the GUI include a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of the GUI are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the GUI is specified in one or more other languages, such as Java, C, or C++.

### 4. Automating an Integration Between a Computing Device Network and a Third-Party Resource

FIG. 2 illustrates an example set of operations for automating an integration between a computing device network and a third-party resource in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments. The example set of operations may be performed by a system such as the system 100 of FIG. 1.

In an embodiment, the system analyzes a GUI meta-specification to identify particular datasets needed for accessing a third-party resource and a data type associated with each particular dataset (Operation 200). The data type (alternatively “datatype”) can be a primitive data type such as String, Boolean, Integer, and/or the like or a user-defined data type as exemplified herein. As described further below in detail, an example particular dataset corresponds to a particular interface element based on at least a datatype of its value or set of values (or alternatively, certain one(s) of its set of values). The system may receive values of the particular datasets as user input via an interface generated from the GUI meta-specification. The system configures the interface to accept the values that comply with the respective data types of their corresponding particular datasets. The values of the particular datasets may be used as input parameters values for a set of functions. The system may further configure the interface to be compatible with the set of functions, specifically, the data types of their function parameters.

The system may analyze the GUI meta-specification and identify an example particular dataset whose value is needed to access the third-party resource. As described further below, such a value is provided as user input via an interface and then, later input into a specific function call parameter(s) for and also later input into a specific function call in integration computer code. These parameters can be defined in terms of attributes including attributes associated with an end user and/or an asset of the computing device network and/or attributes associated with an external service running on a third-party resource. To illustrate by way of example, an endpoint (device) may be parameterized using various attributes including a device name, a network address (e.g., a URL), a set of credentials such as a username and/or password, identity data (e.g., a globally unique identifier (GUID)), and/or the like. In this example, the GUI meta-specification sets forth each attribute's variable name and that variable's data type or data format. In other examples, the GUI meta-specification can specify additional information for each attribute and/or additional attributes for the endpoint.

The system selects an interface layout for generating a GUI that includes interface elements for collecting values for the particular datasets (Operation 202). The interface layout generally refers to an arrangement of a plurality of interface elements of which an interface element can be configured to collect a particular value having a particular data type that is compatible with the interface element type. Hence, the system can select the interface layout based on the interface element type of a particular interface element for collecting the particular value.

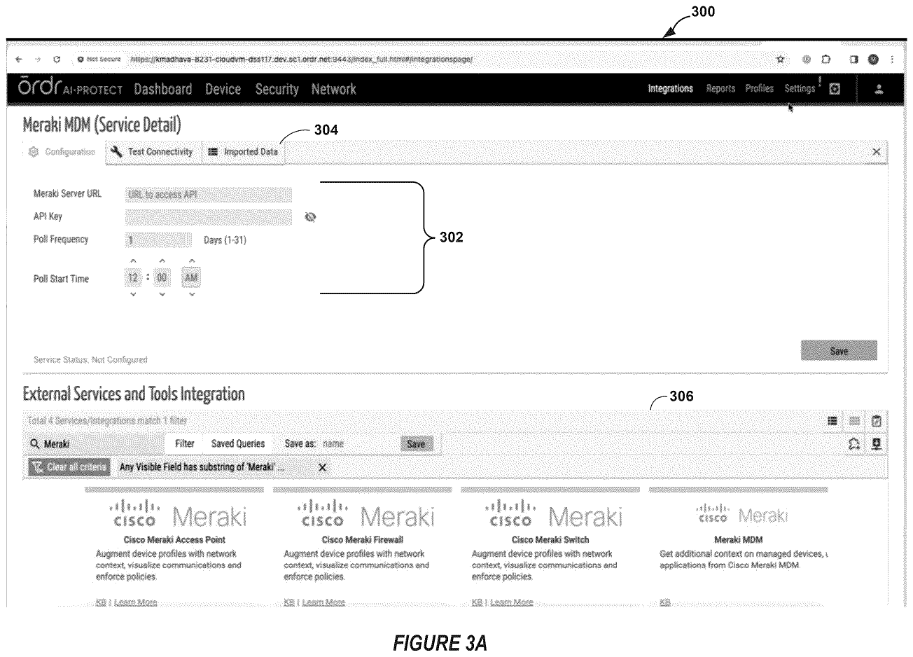

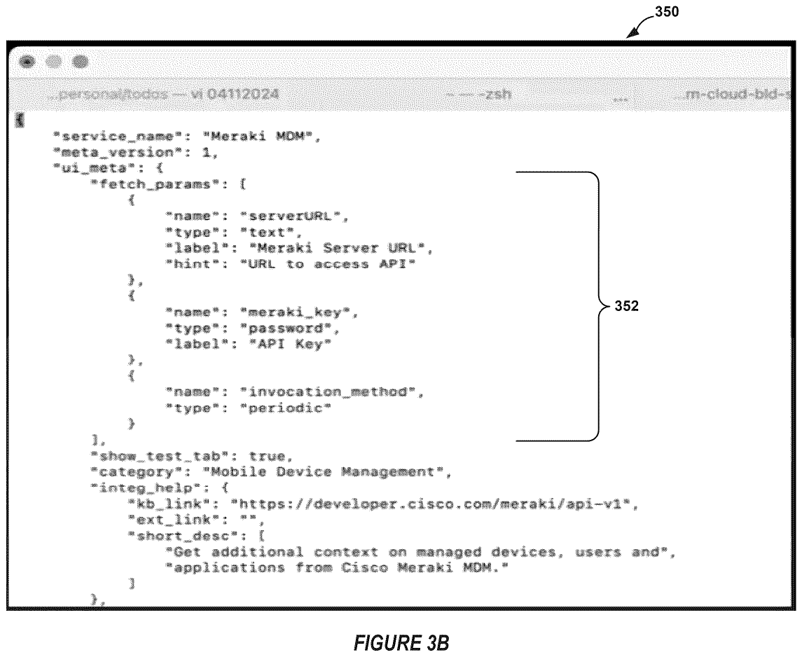

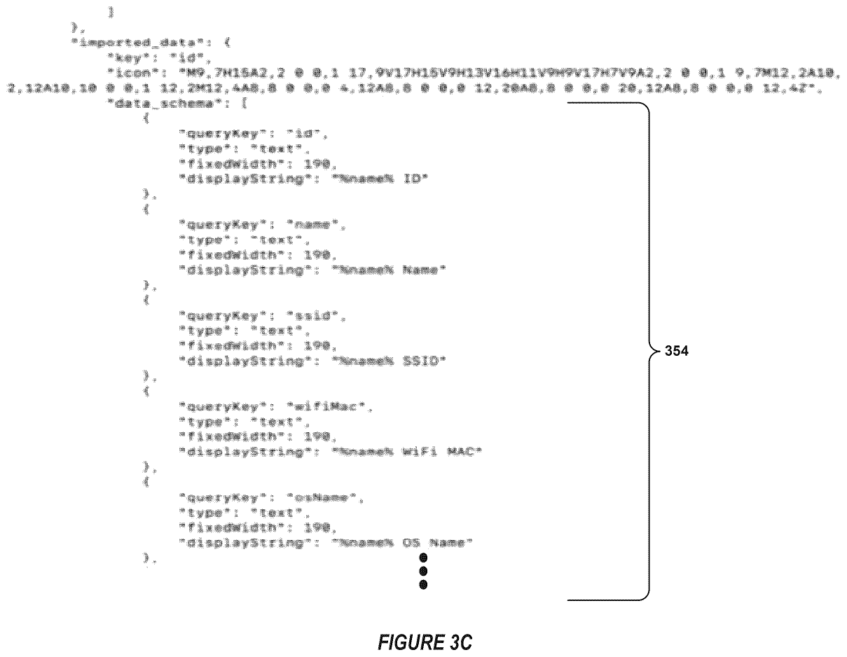

The interface layout may employ a number of interface element types for the plurality of interface elements. One embodiment of the interface layout consists of UI controls, which are interface elements for input, navigation, display controls, and/or the like. One example input control, a checkbox, allows the user to select one or more options from a set of cohesive options. On the other hand, radio buttons allow one option selection at a time. Users are limited to selecting one item at a time in a dropdown menu, while list boxes allow users to select multiple items at a time. An example embodiment of the interface layout is illustrated by FIG. 3A.

The system generates the GUI based on the interface layout (Operation 204). As described herein, the system builds such an interface to facilitate the acquisition of various information of interest from the third-party resource. In one embodiment, the system generates the GUI for presentation on a display device (i.e., a screen) and to prompt the entity's employee or contractor for input related to the integration process. The system selects a plurality of interface elements for collecting values for the particular datasets. The system may select the plurality of interface elements that are compatible with the data types of the particular datasets and then present those interface elements on the GUI. The system can then receive values for the particular datasets via the plurality of interface elements (Operation 206).

By way of an API, the third-party resource can serve a plurality of target datasets to its customers such as the entity. As described herein, the third-party resource, which is a remote cloud resource, runs an external service or application to operate a dedicated instance of the API's functionality for any one or more of its customers. As an alternative, a software agent for the entity can run in the remote cloud resource and via a specific dedicated instance, can directly serve the plurality of target datasets to the entity.

Accordingly, the system then analyzes an API meta-specification to identify a first function that returns a particular target dataset (Operation 208). As described herein, the API meta-specification sets forth a set of API functions (e.g., a code template) for the integration process. The first function may refer to a certain API function that receives, as input, one or more values of the particular datasets provided as user input via the above-mentioned GUI. In some embodiments, the system generates, for display on the same GUI, content presenting the particular target dataset among a plurality of target datasets.

Target datasets generally refer to any third-party information that may be of interest to the entity. Some examples provide the entity with proprietary or specialized analyses of different aspects of their computing device network. One such aspect, cybersecurity, may entail generating the plurality of target datasets from regular security scans of one or more devices in the computing device network. A cloud security scan can compile scan reports and other information into a third-party database of detailed security analysis information for the computing device network, its devices, and/or the operations of those devices. By way of the API, the system can access the third-party database over a communication network and direct the cloud security service to subsequently return the plurality of target datasets of the detailed security analysis information. The target datasets of the detailed security analysis information can be particularized for a specific device or grouping of devices, location, device type, network, tenant, and/or the like.

Another example particular target dataset includes a set of attributes for identifying the specific device or device grouping amongst a plurality of devices of the entity's computing device network. There are a number of use cases for this example particular target dataset; as some example use cases, the set of attributes may be unknown to the entity, or a copy of the set of attributes held by the entity may be obsolete and require updating. Another reason for retrieving asset attribute data is to use at least one attribute value as an input parameter value for an API function call. To illustrate, the target dataset may correspond to an endpoint having information of interest in the third-party database such that the corresponding endpoint attribute values can also be used to identify datasets of that third-party database. For instance, after returning attributes identifying a specific endpoint in the network, the endpoint's attribute values can be used as parameter values in subsequent API function calls for retrieving the plurality of target datasets of the above-mentioned detailed security analysis information. As yet another use case, the target dataset may correspond to an isolated device having information in the third-party database such that the corresponding isolated device attribute values can also be used to identify that information. Being disconnected from other devices in the computing device network, the isolated device may not be reachable for the system. However, in each use case, the corresponding endpoint attributes have to be properly named, typed, and/or formatted to be used as parameter values.

The system determines whether or not to authorize generation of computer code based on the API meta-specification and input parameter values from the GUI (Operation 210). In one embodiment, the system renders such a determination based on the set of functions set forth in the API meta-specification for the integration process. As described herein, the API meta-specification includes a code template into which the system inserts the input parameter values to enable execution of the computer code once generated. Having compatible particular dataset values to use as the input parameter values for the set of functions, the system can proceed with generating the computer code.

One embodiment of the API meta-specification may employ placeholders for the input parameter values in the code template. The GUI meta-specification configures the GUI to ensure any input parameter value that the GUI receives is correctly typed, formatted, and named. Given the correctness of the GUI generated from the GUI meta-specification, when the system inserts the corresponding input parameter values, the system successfully transforms the partial computer code in the API meta-specification into the complete computer code for completing the integration process.

If the system determines to authorize code determination generation, the system proceeds to Operation 214. If, on the other hand, the system determines not to authorize code generation, the system proceeds to correct the received values to match the API meta-specification (Operation 212). In one embodiment, the system determines that an input parameter value is misnamed, mistyped, or misformatted and for at least that reason, declines to authorize generation of the computer code.

The system generates a first set of code of the computer code that invokes the first function with a received value for first parameter that is input to the first function (Operation 214). The system receives a returned value for the particular target dataset and generates a second set of code that invokes a second function with the return value for a second parameter that is input to the second function (Operation 216). Both the first set of code and the second set of code generally refer to processor-executable instructions configured to perform the integration process between the computing device network and the third-party database storing the target datasets. Executing the first set of code causes the system to request that the external service return a first particular target dataset, resulting in updating local device information with the returned value. Executing the second set of code further causes the system to use the returned value in the second function call to receive a second returned value of a second particular target dataset and then update the GUI to present at least some of the target datasets and content, indicating progress of the integration process.

In one embodiment, the first set of code and the second set of code may combine into code for performing a specific integration task as described herein. The integration system may analyze the meta-specification to identify a set of functions, defined by the API for the external service or application, that can perform the specific integration task between the third-party database and a customer database. The integration system further identifies a plurality of datasets being used as the parameter values for the set of functions. The integration system generates code that invokes the set of functions with the parameter values that may be received via the GUI or returned via another function call. Hence, the system, using customer provided information via the interface generated from the GUI meta-specification, can use the API meta-specification to generate appropriate computer code to access the third-party database and perform the specific integration task.

Once completed, the computer code may be configured to integrate the target datasets with the third-party database, for instance, first by communicating with the external service or application instance handling the API's functionality, then having that instance return target dataset values by directly invoking a set of API functions and running scripted code for the integration tasks, and last by updating a customer database. The customer database can store asset data including isolated/connected device information, network statistics, flow data, and insights. The asset data may be obtained from remote or local data stores of the entity's computing device network.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

FIG. 3A illustrates an example embodiment for an interface 300 for accessing a third-party database, and FIGS. 3B-3C illustrate separate portions of an example embodiment of a meta-specification 350 from which the interface 300 is generated in accordance with one or more embodiments. The interface 300 of FIG. 3A includes a plurality of interface elements, such as a set of input fields 302, a tab element 304, and a search menu 306. The separate portions of the meta-specification 350 of FIGS. 3B-3C include definitions for a plurality of datasets 352 and a plurality of target datasets 354, respectively. The following describes in detail how the plurality of datasets 352 and the plurality of target datasets 354 can be used to generate the plurality of interface elements for the example embodiment of the interface 300.

The example embodiment for the interface 300 can be generated by an application and/or a service that is communicatively coupled to a cloud resource such a third-party database. As described herein, an interface layout can be selected, based on the meta-specification 350 of FIGS. 3B-3C, for the application and/or service to use to generate the example embodiment of the interface 300 of FIG. 3A. The interface layout determines the type of interface element that should be rendered, for example, when the interface 300 prompts the end user to provide input data of a specific data type or as a selection amongst pre-determined options. As another example, the interface layout can identify an appropriate interface element for enabling user search and selection between different attributes.

An integration system for a computing device network, such as the system 100 of FIG. 1, implements the example embodiment of the interface 300 using respective portions of meta-specification 350 according to one embodiment. A software component, known as a management engine, of the integration system generates the interface 300 for presentation on a display device and handles input/output between the integration system and an end user. Typically, an employee or contractor for the computing device network and/or the integration system would be authorized as end user. The example embodiment of the interface 300 takes the form of a GUI on which various content is presented to the end user. Depending on which specific third-party database the end user requests access, the integration system can determine an appropriate interface layout for the plurality of interface elements of the GUI and then generate the GUI as the example embodiment of the interface 300.

FIG. 3A identifies the set of input fields 302 and the tab element 304 on the interface 300 of FIG. 3A as appropriate interface elements configured to receive, as user input, values of the plurality of datasets 352 of FIG. 3B or to return, as device output, values of the plurality of target datasets 354 of FIG. 3C. FIG. 3A also identifies the search menu 306 for selecting the third-party database from whom access authorization is requested/granted via the values of the plurality of datasets 352 and to retrieve the values of the plurality of datasets 354.

A first portion of the meta-specification 350 depicted in FIG. 3B defines the plurality of datasets 352, whose values are received via the set of input fields 302 as a set of parameters that are necessary for accessing the third-party database. For any given dataset, a corresponding definition in the meta-specification 350 typically includes attribute key-value pair(s), for instance, to specify at least a data type (labelled “type”) and a name (labelled “name”) of a particular parameter. An interface element should be rendered for the GUI if the interface element can receive a value compatible with the specified data type and assign the specified parameter name per the meta-specification 350.

A second portion of the meta-specification 350 depicted in FIG. 3C defines the plurality of target datasets 354, whose values are returned from the third-party database, as a set of tasks necessary for an integration process. The values of the plurality of target datasets 354 can be arranged into a structured format and then rendered on the GUI for presentation to the end user.

As depicted in FIG. 3A, the GUI includes a tab section with a visible tab element denoted by “Configuration” on top of other tab elements. In the tab section, the GUI further includes the set of input fields 302 for receiving values for datasets labelled Meraki Server URL, API Key, Poll Frequency, and Poll Start in FIG. 3A. The values received via the input fields 302 are needed to successfully request access to an external service, “Meraki MDM.” Accompanying the “Configuration” tab element, the GUI presents information describing the external service denoted by “Meraki MDM” as an external service that manages a third-party database for storing additional context information on managed devices. This information can be extracted from the meta-specification 350.

Also depicted in the tab section of FIG. 3A, the GUI includes the tab element 304 denoted as “Imported Data,” a content page for viewing data obtained from the selected third-party database “Meraki MDM.” In one embodiment, navigating to the tab element 304 prompts the GUI to update its interface elements, for instance, by rendering a new content page for the top tab element 304, initiating retrieval of a plurality of target datasets from the third-party database “Meraki MDM,” and then presenting, in a data table or another structured format, the retrieved target values for the target datasets on the new content page.

The GUI depicted in FIG. 3A includes the search menu 306, in general, for enabling search functionality on a variety of resources and providing content informing an end user of each resource's capabilities for a potential integration. The search menu 306 also enables the end user to select a specific service/application API or another example resource to access a hosted third-party database. Further depicted in FIG. 3A, the search menu 306 presents, in the form of search results, a number of third-party databases as selectable options; the “Meraki MDM” third-party database is one of the selectable options. The end user can avail themselves of the search menu 306 to search for and then select the “Meraki MDM” third-party database for an integration with the end user's computer device network.

Selecting the “Meraki MDM” third-party database from the search menu 306 causes generation of the GUI depicted on FIG. 3A according to one embodiment. The meta-specification 350 can set forth information mapping appropriate interface layouts to different third-party databases. The meta-specification 350 can further define the appropriate interface layout for the “Meraki MDM” third-party database, as an example, by directing placement and/or type of some (if not all) plurality of interface elements, such as the input fields 302 and the tab element 306, on the GUI. The above definition can be used advantageously when responding to a database selection, for instance, by generating the GUI depicted on FIG. 3A.

At least part of the meta-specification 350 includes a plurality of datasets 352, each of which includes one or more data values that can used for obtaining authorized access to (and/or retrieving relevant information from) a third-party database or another cloud resource. One embodiment of the meta-specification 350 configures the plurality of datasets 352 to define a set of parameters that are to be received via the GUI and inserted into function calls to the third-party database or another cloud resource; each of the datasets 352 codifies a formal definition prescribing a mandatory data type, a descriptive label, and a name/naming convention for a particular parameter. One embodiment of the plurality of datasets 352 includes tabular field names and values for running queries against data tables stored in the third-party database or another cloud resource. Another embodiment of the plurality of datasets 352 includes user credentials and other information for authenticating the end user and granting access rights to the third-party database.

The meta-specification 350 also may identify an external service that controls or manages access to the third-party database. The external service exposes a set of service API functions that can be invoked (i.e., called) through several mechanisms such as through RESTful communications. One embodiment of the integration system submits various function calls to the external service for obtaining access and/or retrieving relevant information. In addition to the name of each particular parameter for the various function calls, the plurality of datasets 352 provides supplemental information, including an appropriate data type for each parameter value. By doing so, the meta-specification 350 can ensure compatibility between any input received via the GUI and the various function calls needed to access the third-party database.

The example embodiment of the meta-specification 350 sets forth the plurality of datasets 352 as including a first set of definitions for a set of parameters denoted by “serverURL,” “Meraki_key,” and “invocation_method” (hereinafter serverURL, Meraki_key, and invocation_method) in FIG. 3B. The first set of definitions form a schema that can be used to correctly generate the GUI with an appropriate interface layout, for example, by ensuring the set of input fields 302 are appropriately labelled and typed interface elements. At least one of more of the set of input fields 302 corresponds to the set of parameters of the plurality of datasets 352, and vice versa. Reflecting label attributes of the above schema, the set of input fields 302 depicted in FIG. 3A, “Meraki Server URL” and “API Key,” are illustrative examples of corresponding labels for the above set of parameters (except for invocation_method). Although the above set of parameters depicted in FIG. 3B include invocation_method as a parameter, invocation_method is not among the set of input fields 302 further depicted in FIG. 3A, thereby indicating that it is possible for more (or fewer) parameters to be used in accessing the third-party database. In one embodiment, the integration system can use the first definitions to select appropriate interface elements for and then generate at least some (if not all) of the set of input fields 302 depicted in FIG. 3A.

As depicted in FIG. 3C, the example embodiment of the meta-specification 350 sets forth a second set of definitions denoted by “id,” “name”, “ssid”, “wifiMAC,” and “osName” (hereinafter id, name, ssid, wifiMAC, and osName) for the plurality of target datasets 354. A service API exposed by the cloud resource can be invoked to return values for these datasets 354 from the third-party database. Received values for the plurality of datasets 352 are transformed into the service API function parameters serverURL and Meraki_key. The second set of definitions form a schema from which a content page for an “Imported data” tab element 304 can be correctly generated. In one embodiment, the data schema for the “Imported data” tab element 304 sets forth a structured format to present values for the set of target datasets 354. To enable the structured format, each of the second set of definitions refers to a pre-configured query that the cloud resource executes in response to receiving parameters serverURL and Meraki_key in a particular function call. In one embodiment, the cloud resource can apply the pre-configured query to the third-party database and generate values for a corresponding target dataset 354 that can be returned to the integration system for presentation on the GUI.

In one embodiment, the meta-specification 350 may include markup data configured to encode a plurality of interface elements of the interface layout. The markup data, when rendered by a software application such as an Internet content application, causes the GUI to present the plurality of interface elements. A particular interface element may be selected for the interface layout and, specifically, for receiving a value for a particular dataset/function parameter. The integration system may render such a selection upon determining that the particular interface element is appropriate for receiving such a value, for instance, based on a corresponding data type of particular dataset/function parameter. Alternatively, the selection of particular interface element for the interface layout may be pre-determined and thus, hard coded into the markup data prior to the generation of the GUI.

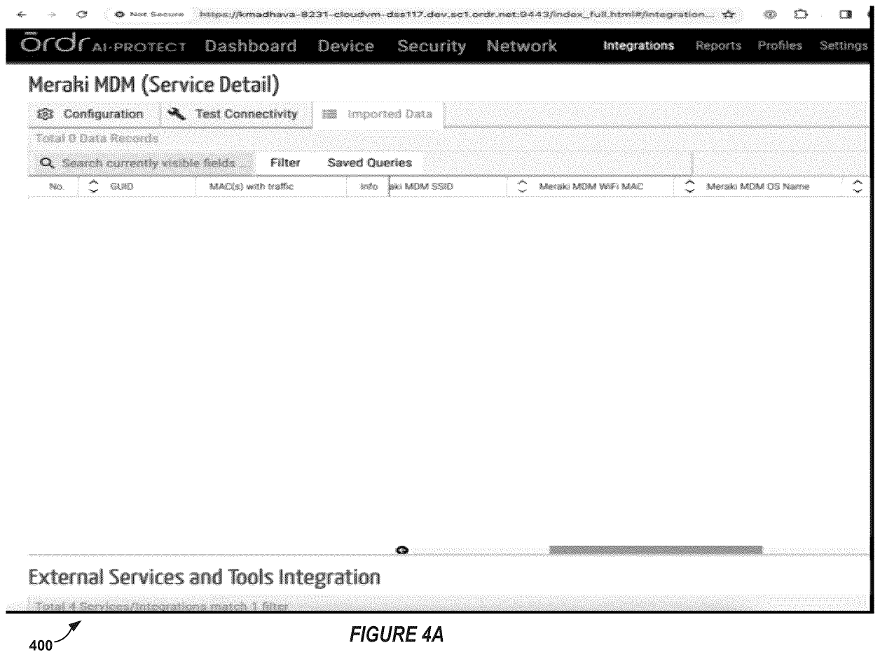

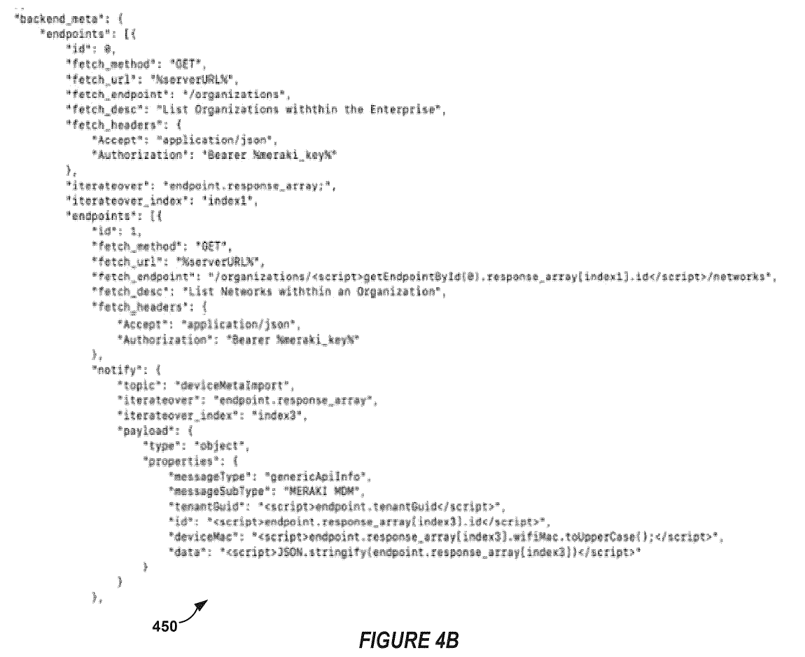

Comparing an API meta-specification, such as the meta-specification 450 depicted in FIG. 4B, to the meta-specification 350 of FIGS. 3B-3C, a GUI meta-specification, there are several differences allowing each to be used separately and independently. While the GUI meta-specification generally codifies a schema for datasets that are input and/or output via a GUI, the API meta-specification generally codifies a workflow for functions that are instantiated and then executed by a system. Nevertheless, examples combining both can be implemented in several ways according to some embodiments. For instance, a single markup language document can combine the meta-specification 450 of FIG. 4B with the meta-specification 350 of FIGS. 3B-3C.

FIG. 4A illustrates an example embodiment for an interface 400 for presenting results from executing integration computer code on a third-party database, and FIG. 4B illustrates an example embodiment of a meta-specification 450 for generating the integration computer code in accordance with one or more embodiments.

An integration system as described herein implements, as a GUI, the example embodiment for the interface 400 depicted in FIG. 4A. The example embodiment of the interface 400 is configured to present, via a tab element of a tab section, tabular data populated with values corresponding to target datasets that are stored in a third-party database.

In one embodiment, the integration system generates the interface 400 using a template. The template may be a markup language document, such as a HTML document, in which markup data (e.g., a plurality of HTML elements) codifies at least a portion of an interface layout for the interface 400 while the metadata stores the meta-specification 450. The markup data may identify a plurality of interface elements to include in the interface layout for the interface 400. The markup data, when rendered by an Internet content application, causes the GUI to present the plurality of interface elements on the GUI. These interface elements may be determined by the integration system based on output data types, or they may pre-determined and hardcoded into the markup data at some point before starting the integration process.

Depending on the third-party database, the meta-specification 450 sets forth a number of compliant API function calls for completing the integration process. The meta-specification 450 generally includes a workflow that complies with an API for the third-party database, and in one embodiment, the workflow includes computer code that iterates through a series of API function calls for the integration process between device network and the third-party database. The meta-specification 450 pre-configures the computer code with appropriate parameters and well-defined API function calls such that compatible input values can be accepted without error, and unknown target datasets can be identified without failure. Each pre-defined API function call directed to the third-party database is operative to retrieve values for the target datasets such as the plurality of target datasets 354 of FIG. 3C. The integration system receives the values corresponding to the target datasets by executing the integration computer code.

The integration system as described herein can generate the integration computer code from the meta-specification 450, for instance, by implementing a set of pre-defined API functions as set forth in the meta-specification 450. In one embodiment, the meta-specification 450 defines workflow logic for calling the set of pre-defined API functions, yet it requires function parameter values for the integration system to fully generate the integration computer code. As such, the meta-specification 450 constitutes an incomplete version of the integration computer code. In one embodiment, the meta-specification 450 includes computer code that is in a compatible language or is at least interoperable with the integration computer code. The integration system can insert parameter values into the computer code invoking the pre-defined functions. As described herein, one or more of these parameters can be defined in another meta-specification, such as the GUI meta-specification, and then received as input via the GUI.

In one embodiment, the meta-specification 450 identifies which specific API function to call to submit as input a particular parameter and/or to obtain a particular target dataset. In one embodiment, the meta-specification 450 sets forth a chain of API function calls forming a portion of the integration computer code. For ease of explanation, the integration computer code can be generated by incorporating the computer code in the meta-specification 450 and possibly adding/modifying one or more instructions of that computer code.

In one embodiment, the integration system generates the integration computer code using the same template as (or a different template from) the above template used for generating the interface 400. The template may store in its metadata both the meta-specification 350 and/or stores the meta-specification 450. The template can therefore be used to generate the integration computer code for performing the integration process while enabling the end user to monitor its progress and view results via the interface 400. In one embodiment, the computer code in the meta-specification 450 may be considered a complete version of the above-mentioned integration computer code except for the specific API function calls that require particular parameter values. Some of these parameters can be used to authenticate an end user and access a third-party database being managed by an external service.

While the integration computer code can be generated for performing the entirety of integration process, some embodiments can generate example computer code for completing a specific integration task. In one embodiment, the integration system can analyze the meta-specification 450 to identify a set of functions, defined by the API for the external service, that can perform the specific integration task, for instance, between the third-party database and a customer database. The integration system further identifies a plurality of datasets (of a first meta-specification) being used as the input parameters for the set of functions. Responsive to receiving values for the plurality of datasets via a plurality of interface elements of a GUI that was generated using the first meta-specification, the integration system generates code that invokes the set of functions with the received values for the plurality of datasets as the input parameters.

The meta-specification 450 can be combined with the input parameter values to complete the integration computer code for performing the integration process; otherwise, the integration computer code is incomplete and cannot be executed due to missing or incorrect parameter data among other reasons. Parameter values can be provided as input from the end user or returned as a function result and should be compatible with their matching API function calls. If a given API function requires an example parameter with a parameter name and data type, the same parameter should be defined in the meta-specification 350. Other reasons for the integration code to be incomplete include having function parameter data that is mistyped, mis-formatted, misnamed, or otherwise unsuitable for execution.

The meta-specification 450 thereby ensures that the integration computer code, including any code statements regarding API function parameters and/or target datasets, follow definitions set forth in at least the meta-specification 350. It should be noted that if the input parameter values are incorrect the meta-specification 450 is capable of enforcing compatibility between a given API function parameter and a corresponding input value, for instance, by normalizing, and/or converting the input parameter value into an acceptable value. Compatibility can be gauged by way of a metric for matching attributes between both definitions.

In one embodiment, the integration system analyzes the meta-specification 450 corresponding to an API for the third-party database to identify a first function that returns a particular target dataset and generates a first set of code that invokes the first function with the particular value, received via the particular interface element on the GUI, for the first parameter that is input to the first function. The integration system next analyzes the meta-specification 450 to identify a second function, defined by the API, that (a) returns a second target dataset and (b) accepts as an input parameter a second value of a second type that is returned by the first function, generating a second set of code that invokes the second function using the second value that is returned by the first function as an input to the second function. The integration system proceeds to execute the first set of code and the second set of code invoking the first and second functions, respectively, causing an external service to perform tasks for the integration process.

The meta-specification 450 of FIG. 4B references an enterprise, which can be the entity described herein for operating a computing device network, and organizations, which can be the entity's clients. The entity can be a customer of the integration system and a tenant (i.e., a client organization) of a Cloud Service Provider (CSP) and/or itself a CSP with the client organizations as its own tenants. Accordingly, some embodiments may have the entity operate an (enterprise) cloud system with at least one computing device network and a number of computing devices being managed (at least in part) by an external service. The enterprise can run a multi-tenant cloud system, thereby hosting a number of cloud environments for its client organizations so that each client organization can manage one or more computing device networks. The external service generally monitors operations in a given computing device network, logs various datasets, and then generates insights regarding the network as a whole, its devices, and/or any of their operations. These devices, typically referred to as managed devices, include at least some (if not all) of the entity's endpoints.

Regarding the example embodiment of FIG. 4B, the third-party database denoted by “Meraki MDM” uses the serverURL to identify the entity and/or the entity's computing device network(s). The entity can configure a specific connected device as an endpoint and then further configure that endpoint as an ingress for the external service managing the third-party database. The entity can assign serverURL to that specific endpoint. Alternatively, the parameter serverURL may be a generic identifier for the entity's computing device network(s). In case of multiple computing device networks, the serverURL identifies a specific one of those multiple computing device networks.

As further depicted in FIG. 4B, values for parameters Meraki_key and serverURL are needed for a service API function call. The service API function can be invoked to successfully obtain target datasets enumerating endpoint devices (or simply endpoints). These endpoints are computing devices and either physically reside or operate as virtual containers/devices in a computing device network. It is possible for the above entity and one of its client organizations to be customers of the integration system. It also is possible for the above entity to be a tenant in another enterprise's cloud system, in which case, the integration system's operation would remain unchanged.

The meta-specification 450 of FIG. 4B includes a computer code for recursively discovering endpoints in each network of each organization in the entity's cloud system (i.e., the enterprise) according to one embodiment of the meta-specification 450. The meta-specification 450 includes a first function call for executing an API function denoted by “getEndpointById” (hereinafter getEndpointById). The getEndpointById may refer to an identified meta-specification snippet of the meta-specification. The code may be configured to retrieve (as a target dataset) various information for an endpoint in a computing device network. An example target dataset comprises a set of attributes for identifying endpoint related information in the third-party database denoted by “Meraki MDM.” While an ID attribute alone can distinguish a specific endpoint amongst a plurality of customer assets in the computing device network per getEndpointById, other endpoint attributes may be needed to retrieve additional information from the third-party database denoted by “Meraki MDM.” For instance, the meta-specification 450 describes using the endpoint attribute data, returned by the first function call to getEndpointById, as input parameter data for a second function call such as the scripted code for wifiMac as depicted in FIG. 4B. The GUI of the interface 400 includes a plurality of interface elements for presenting an example second target dataset from executing a set of code that invokes the first function using the endpoint attribute data as input for the first parameter.

For each function call, the endpoint attributes have to be properly named, typed, and/or formatted prior to being used as parameter values. In one embodiment, the integration system generates the integration computer code in which endpoint attribute values are determined to be compatible with corresponding parameters in the API function calls, thereby permitting their insertion into these function calls as input parameter values. In one embodiment, the integration system assigns a same parameter name as a corresponding API function parameter to a given endpoint attribute value. If found to be mistyped and/or mis-formatted, the integration system converts the endpoint attribute value into a properly typed and/or properly formatted parameter value for an API function call.

The meta-specification 450, in FIG. 4B, may include scripted code for massaging data to be sent as payload or data received as response and/or for executing a particular API function that retrieves device MAC address data denoted by “wifiMac” (hereinafter wifiMac). The device MAC address data may include a specifically formatted MAC address for an endpoint in the computing device network. In one embodiment, executing the particular API function results in applying a pre-configured query on the third-party database and generating values for a corresponding target dataset denoted by “Meraki MDM WiFi MAC” in FIG. 4A. The pre-configured query can be applied to a table of endpoint attribute data generated by another API function.

In general, input parameter values for any API function call are required to be compatible with the integration system and/or the external service when executing the integration computer code. The meta-specification 450 can be leveraged to enforce their type and format requirements during the integration process. Values for parameters meraki_key and serverURL, in particular, are needed for executing a particular API function for requesting access to the third-party database denoted by “Meraki MDM” in FIG. 4A. Successfully accessing information in the third-party database denoted by “Meraki MDM” in FIG. 4A requires both parameter values to be compatible, for instance, in an acceptable data type and, possibly, format. Although an example parameter can be expressed with some variety using different data types and/or formats, the above API function accepts the parameter values as input if both values comply with the meta-specification 450 and any type and format set forth therein.

In a number of ways, the meta-specification 450 can ensure that each function parameter is properly typed and formatted. The meta-specification 450 may include code snippets for correcting type/format incompatibility according to one embodiment. The code snippets may perform the correction before presenting the parameter value on the GUI, inserting the parameter value into a different API function call, or both. An example code snippet may activate in response to determining a mistyped input parameter value. The mistyped input parameter value may be received from the end user or returned from the third-party database. The example code snippet can correct the mistyped input parameter value by way of conversion to an appropriate input parameter value. In another embodiment, the meta-specification 450 can assume each API function parameter has a correct name, data type, and/or format.

The example code snippet may include scripted code operative to convert an endpoint attribute into a different format (i.e., normalization). To illustrate by way of example, the example code snippet may include scripted code configured to call a function denoted by “toUpperCase()” and change an attribute value, by way of capitalization, into an appropriate value for the function call. As depicted in FIG. 4B, an endpoint device having an identifier attribute labelled “id” has a MAC address attribute labelled “wifiMac” that is transformed into an upper case format by way of a “toUpperCase()” function call. FIG. 4B depicts a dataset labelled “deviceMac” that results from the function call and is eventually presented on an interface element (e.g., an output field such as a text block) of the interface 400 of FIG. 4A.

Alternatively, another meta-specification can enforce type and format requirements, such as the meta-specification 350 of FIG. 3A that defines an acceptable type and format for values, received or otherwise, for parameters meraki_key and serverURL via the interface 300. The meta-specification 350 as depicted in FIG. 3A defines a set of attributes for each parameter meraki_key and serverURL; responsive to determining that one or both particular values, received via a particular interface element on the interface 300 of FIG. 3A, is compatible with an attribute type or an attribute format, the integration system proceeds to input these values into API function calls. The meta-specification 350 of FIG. 3A also defines an attribute name and enforces that definition to ensure that the meta-specification 450 uses correct names for the input parameters meraki_key and serverURL.

### 6. Computing Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

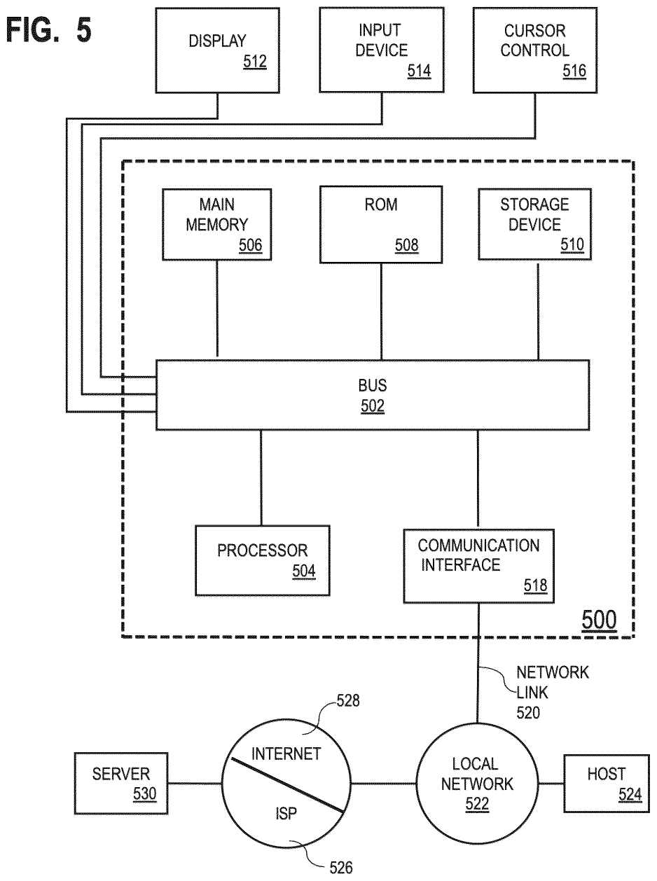

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
analyzing a meta-specification to identify (a) a plurality of datasets needed for accessing a third-party resource, and (b) a data type associated with each of the plurality of datasets;
selecting an interface layout for generating a graphical user interface (GUI) that includes a plurality of interface elements for collecting values for the plurality of datasets,
wherein a particular interface element, of the plurality of interface elements, for collecting a particular value for a particular dataset is selected based on the data type associated with the particular dataset; and
generating the GUI based on the interface layout.

2. The method of claim 1, wherein selecting the interface layout further comprises selecting a checkbox control for a Boolean data type associated with a first dataset of the plurality of the datasets.

3. The method of claim 1, wherein selecting the interface layout further comprises selecting a form field control for a String data type associated with a first dataset of the plurality of the datasets.

4. The method of claim 1, wherein selecting the interface layout further comprises selecting a dropdown menu control for an Integer data type associated with a first dataset of the plurality of the datasets.

5. The method of claim 1, wherein the particular value is associated with a first parameter for a first function corresponding to an Application Programming Interface (API) for the third-party database.

6. The method of claim 5, wherein generating the GUI further comprises:
generating the GUI that includes a second plurality of interface elements for presenting a particular target dataset from executing code that invokes the first function using the particular value as input for the first parameter.

7. The method of claim 5, wherein the meta-specification further comprises a code snippet for transforming the particular value into an appropriate value for the first parameter.

8. The method of claim 6, the particular value having a different format than the appropriate value.

9. The method of claim 5, wherein the particular value for the particular dataset of the plurality of datasets corresponds to an endpoint having information in the third-party database, wherein the first function returns a set of attributes for an endpoint.

10. The method of claim 9, wherein the plurality of datasets further comprises a set of attributes for identifying the endpoint and accessing the information in the third-party database.

11. The method of claim 10, wherein the meta-specification identifies an attribute name and an attribute type or an attribute format for a first attribute of the set of attributes, wherein the particular interface element for collecting the particular value is selected based on the attribute type or the attribute format.

12. The method of claim 10 further comprising:
responsive to determining that the particular value, received via the particular interface element on the GUI, is compatible with the attribute type or the attribute format, generating code in which the particular value is assigned the attribute name and inserted into a function call as the first parameter for the first function.

13. The method of claim 5, wherein the meta-specification comprises a first meta-specification, the method further comprising:
analyzing a second meta-specification corresponding to the API for the third-party database to identify the first function that returns a particular target dataset; and
generating a first set of code that invokes the first function with the particular value, received via the particular interface element on the GUI, for the first parameter that is input to the first function.

14. The method of claim 13 further comprising:
analyzing the second meta-specification to identify a second function, defined by the API, that (a) returns a second target dataset and (b) accepts as an input parameter a second value of a second type that is returned by the first function; and
generating a second set of code that invokes the second function using the second value that is returned by the first function, as an input to the second function.

15. The method of claim 1, wherein the meta-specification further comprises markup data for identifying the plurality of interface elements of the interface layout, wherein the markup data, when rendered by an Internet content application, causes presentation of the plurality of interface elements on the GUI.

16. The method of claim 1 further comprising:
analyzing the meta-specification corresponding to an API for the third-party database to identify a set of functions, defined by the API, that perform an integration task between the third-party database and a customer database, wherein the meta-specification further identifies the plurality of datasets as input parameters for the set of functions; and
generating code that invokes the set of functions with received values, via the GUI, for the plurality of datasets as the input parameters for the set of functions, wherein the GUI further includes a second plurality of interface elements for presenting integration task results from executing the generated code that invokes the set of functions with received values.

17. A method comprising:
using customer provided information, via an interface generated from a first meta-specification operative to identify (a) a plurality of datasets needed for accessing a third-party cloud, and (b) a data type associated with each of the plurality of datasets, to generate computer code to access the third-party cloud;
analyzing a meta specification corresponding to an Application Programming Interface (API) for the third-party cloud to identify a first function, defined by the API, that returns a first target dataset;
analyzing the first function to determine a first type corresponding to a first parameter that is input to the first function; and
generating a first set of code that invokes the first function with a first value of the first type corresponding to the first parameter that is input to the first function.

18. The method of claim 17, further comprising:
analyzing the API to identify a second function, defined by the API, that (a) returns a second target dataset and (b) accepts as an input parameter a second value of a second type that is returned by the first function; and
generating a second set of code that invokes the second function using a return value, that is returned by the first function, as an input to the second function.

19. The method of claim 18, further comprising:
executing the first set of code that invokes the first function with the first value of the first type corresponding to the first parameter that is input to the first function; and
executing the second set of code that invokes the second function using the return value, that is returned by the first function, as an input to the second function.

20. A system comprising:
at least one device including a hardware processor;
the system being configured to perform operations comprising:
analyzing a meta-specification to identify (a) a plurality of datasets needed for accessing a third-party database, and (b) a data type associated with each of the plurality of datasets;
selecting an interface layout for generating a graphical user interface (GUI) that includes a plurality of interface elements for collecting values for the plurality of datasets, wherein a particular interface element, of the plurality of interface elements, for collecting a particular value for a particular dataset is selected based on the data type associated with the particular dataset; and
generating the graphical user interface (GUI) based on the interface layout.
